(19) United States
(12) Patent Application Publication
(10) Pub. No.: US 2020/0317190 A1
(43) Pub. Date: Oct. 8, 2020

(54) Collision Control Method, Electronic Device and Storage Medium

(71) Applicant: Shenzhen Sensetime Technology Co., Ltd., Shenzhen (CN)

(72) Inventors: Yuanyang Tong, Shenzhen (CN); Ningyuan Mao, Shenzhen (CN); Wenzhi Liu, Shenzhen (CN)

(73) Assignee: Shenzhen Sensetime Technology Co., Ltd., Shenzhen (CN)

(21) Appl. No.: 16/906,076

(22) Filed: Jun. 19, 2020

Related U.S. Application Data
(63) Continuation of application No. PCT/CN2019/084529, filed on Apr. 26, 2019.

(30) Foreign Application Priority Data
Apr. 28, 2018 (CN) 201810403429.3

(51) Int. Cl. B60W 30/09; B60W 30/095; B60W 50/14; G06N 3/02

(52) U.S. Cl. CPC B60W 30/09; B60W 30/0956; B60W 2050/143; G06N 3/02; B60W 2420/42; B60W 50/14

(57) ABSTRACT

The present disclosure relates to a collision control method and apparatus, an electronic device, and a storage medium. The method includes: detecting a target object in an image photographed by a current object; determining a danger level of the target object; and executing collision control corresponding to the danger level.

The present application claims priority to Chinese Patent Application No. 201810403429.3, filed to the Chinese Patent Office on Apr. 28, 2018 and entitled “COLLISION CONTROL METHOD AND APPARATUS, ELECTRONIC DEVICE, AND STORAGE MEDIUM”, which is incorporated herein by reference in its entirety.

### TECHNICAL FIELD

The present disclosure relates to the technical field of computer vision, and in particular, to collision control methods and apparatuses, electronic devices, and storage media.

### BACKGROUND

When driving a vehicle intelligently, it is necessary to sense targets such as passersby and other vehicles by using a computer vision technology, and to use the sensed targets for decision-making of intelligent driving of the vehicle.

### SUMMARY

The present disclosure provides technical solutions of collision control.

According to one aspect of the present disclosure, a collision control method is provided, including:

detecting a target object in an image photographed by a current object;

determining a danger level of the target object; and

executing collision control corresponding to the danger level.

According to one aspect of the present disclosure, a collision control apparatus is provided, and the apparatus includes:

a detection module, configured to detect a target object in an image photographed by a current object;

a determination module, configured to determine a danger level of the target object; and

an execution module, configured to execute collision control corresponding to the danger level.

According to one aspect of the present disclosure, an electronic device is provided, including:

a processor; and

a memory configured to store processor-executable instructions;

the processor executes the collision control method by directly or indirectly calling the executable instructions.

According to one aspect of the present disclosure, provided is a computer readable storage medium, having computer program instructions stored thereon, wherein when the computer program instructions are executed by a processor, the collision control method is implemented.

According to one aspect of the present disclosure, provided is a computer program, including computer readable codes, wherein when the computer readable codes run in an electronic device, a processor in the electronic device executes instructions for implementing the collision control method.

In the embodiments of the present disclosure, by detecting a target object in an image photographed by a current object and determining a danger level of the target object to perform corresponding collision control, accurate and targeted collision control for the target object is implemented.

Other features and aspects of the present disclosure can be described more clearly according to the detailed descriptions of the exemplary embodiments in the accompanying drawings below.

### BRIEF DESCRIPTION OF THE DRAWINGS

The accompanying drawings included in the specification and constituting a part of the specification illustrate the exemplary embodiments, features, and aspects of the present disclosure together with the specification, and are used for explaining the principles of the present disclosure.

FIG. 1 is a flowchart illustrating a collision control method according to one embodiment of the present disclosure;

FIG. 2 is a flowchart illustrating a collision control method according to one embodiment of the present disclosure;

FIG. 3 is a flowchart illustrating a collision control method according to one embodiment of the present disclosure;

FIG. 4 is a flowchart illustrating a collision control method according to one embodiment of the present disclosure;

FIG. 5 is a flowchart illustrating a collision control method according to one embodiment of the present disclosure;

FIG. 6 is a block diagram illustrating a collision control apparatus according to one embodiment of the present disclosure; and

FIG. 7 is a block diagram illustrating an electronic device according to one embodiment of the present disclosure.

### DETAILED DESCRIPTION

Various exemplary embodiments, features, and aspects of the present disclosure are described below in detail with reference to the accompanying drawings. The same reference numerals in the accompanying drawings represent elements having the same or similar functions. Although the various aspects of the embodiments are illustrated in the accompanying drawings, unless stated particularly, it is not required to draw the accompanying drawings in proportion.

The special word “exemplary” here means “used as examples, embodiments, or descriptions”. Any “exemplary” embodiment given here is not necessarily construed as being superior to or better than other embodiments.

In addition, numerous details are given in the following detailed description for the purpose of better explaining the present disclosure. It should be understood by persons skilled in the art that the present disclosure can still be implemented even without some of those details. In some examples, methods, means, elements, and circuits that are well known to persons skilled in the art are not described in detail so that the principle of the present disclosure becomes apparent.

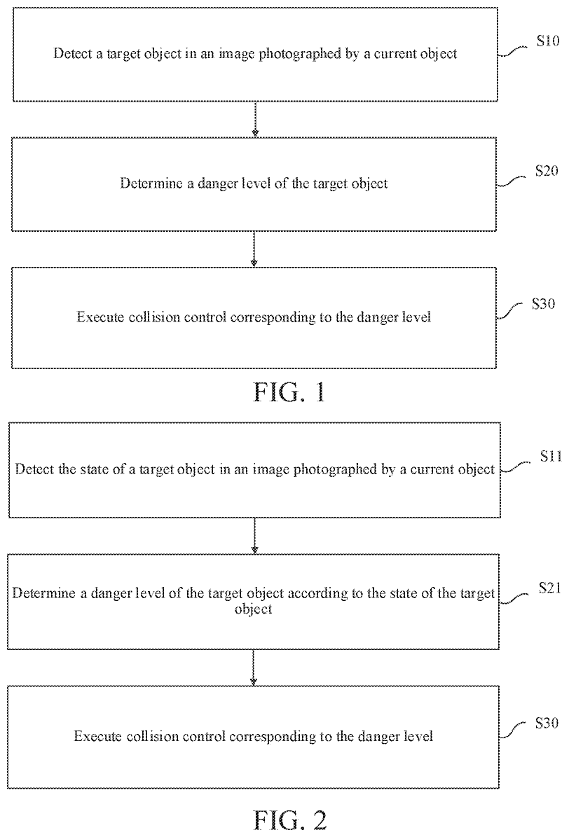

FIG. 1 is a flowchart illustrating a collision control method according to one embodiment of the present disclosure. As shown in FIG. 1, the method includes the following steps. At step S10, a target object in an image photographed by a current object is detected.

The target object may be any type of object, for example, the target object may include at least one of the following: a passerby, a vehicle, an animal, a plant, an obstacle, a robot, and a building. The target object may be a single or multiple target objects in one object type, and may also be multiple target objects in multiple object types. For example, only a vehicle is used as the target object, the target object may be one vehicle, and may be multiple vehicles. Vehicles and passersby may also be jointly used as the target objects. The target objects are multiple vehicles and multiple passersby. According to requirements, a set object type may be used as the target object, and a set individual object may also be used as the target object.

The current object may include a movable object, and may also include an immovable object. The current object may be a driving object, for example, a moving vehicle, and may also be a static object, for example, a building and a roadside monitoring device.

The current object may include a person, a motor vehicle, a non-motor vehicle, a robot, a wearable device and the like. When the current object is a vehicle, the embodiments of the present disclosure may be applied to the technical fields such as automatic driving and assistant driving. When the current object is a monitoring device provided at the roadside, the embodiments of the present disclosure may be used for preventing the target object from colliding with the monitoring device. No limitation is made thereto in the present disclosure.

A photographing apparatus may be mounted on the current object to photograph an image in a set direction. The current object may photograph images in any one or more directions such as the front, rear, and side directions of the current object. No limitation is made thereto in the present disclosure.

The image photographed by the current object may include a single frame image photographed by using the photographing apparatus, and may also include frame images in a video stream photographed by using the photographing apparatus.

The current object may use various visual sensors, such as a monocular camera, an RGB camera, an infrared camera, and a binocular camera, for photographing images. Using a monocular camera system results in low cost and a swift response. The RGB camera or the infrared camera may be used for photographing images in a special environment. The binocular camera may be used for obtaining richer information of the target object. Different photographing devices may be selected and used according to anti-collision requirements, the environment and the type and cost of the current object and the like. No limitation is made thereto in the present disclosure.

The result obtained by detecting the target object in the image photographed by the current object may include the features of the target object, and may also include the state and the like of the target object. For example, the detection result is that the target object is the aged, and the state of the target object includes moving at a slow speed, looking down at a mobile phone and the like. No limitation is made thereto in the present disclosure.

At step S20, a danger level of the target object is determined.

The target object in the image photographed by the current object may cause a danger to the current object, for example, the target object photographed by a camera in the front of a vehicle is in danger of being hit by the vehicle. Different target objects may have different danger levels, for example, the target object moving fast toward the current object has a higher danger level, and the target object located in front of the target object and moving slowly has a higher danger level, and the like. A corresponding relationship between the target object and the danger level, for example, a corresponding relationship between the feature or state of the target object and the danger level, may be established, and thus the danger level of the target object is determined according to the corresponding relationship.

In an example, the danger levels of the target object may be divided according to danger and safety, etc., and may also be divided according to a first danger level, a second danger level, a third danger level, and the like.

The danger level of the target object may be determined according to the target object detected on the basis of a single image, for example, the detection result is that the feature of the target object is the aged, and the danger level of the aged is high. The danger level of the target object may also be determined according to the state of the target object detected on the basis of multiple images, for example, the detection result is that the target object is approaching the current object at high speed, and the danger level is high.

At step S30, collision control corresponding to the danger level is executed.

Different collision controls may be adopted for different danger levels to warn or avoid danger, a corresponding relationship between the danger levels and collision controls may be established, and thus corresponding collision control is determined according to the determined danger level.

In the embodiments of the present disclosure, by detecting the target object in the image photographed by the current object and determining the danger level of the target object to perform corresponding collision control, accurate and targeted collision control for the target object is implemented.

In a possible implementation, the detecting the target object in the image photographed by the current object may include: detecting the target object in the image photographed by the current object by means of a neural network.

The neural network may be trained by using a training image set constructed by images comprising various target objects, and the target object in the photographed image is identified by using the trained neural network. A training process of the neural network and a process of detecting the target object by means of the neural network may be implemented by means of the related technologies.

The neural network may be based on architectural approaches such as Region-based Fully Convolutional Networks (RFCN), a Single Shot multibox Detector (SSD), a Regions-based Convolutional Neural Network (RCNN), a FastRCNN (Fast RCNN), a FasterRCNN (Faster RCNN), Spatial Pyramid Pooling Convolutional Networks (SPPNet), Deformable Parts Models (DPM), an OverFeat, and You Only Look Once (YOLO). No limitation is made thereto in the present disclosure.

For example, a movement state and a behavior state of the target object may be detected by tracking the same target object in multiple continuous frames of video images by means of an image tracking technology based on error Back Propagation (BP) or other types of neural networks, for example, it is detected that the target object moves from the left front to the right front of the current object (such as a vehicle), and looks straight ahead, and the like.

For another example, the distance between the target object and the current object may be determined by using an image photographed by the binocular camera by means of a binocular distance measurement technology based on RCNN or other types of neural networks.

In the embodiments, the target object is detected on the basis of the neural network, and the target object may be quickly and accurately detected in the image by using a powerful and accurate detection function of the neural network. FIG. 2 is a flowchart illustrating a collision control method according to one embodiment of the present disclosure. As shown in FIG. 2, step S10 may include the following step.

At step S11, the state of the target object in the image photographed by the current object is detected.

Step S20 may include the following step.

At step S21, the danger level of the target object is determined according to the state of the target object.

The state of the target object may be any type of state, for example, may be a static action made by the target object or a dynamic state, and may also be its own attribute state and the like of the target object.

In a possible implementation, a static state of the target object is detected according to a photographed single static image. For example, the static state of a target object passerby is detected to look down at the mobile phone or the passerby is the aged according to the single static image. A dynamic state of the target object is also detected according to multiple associated images. For example, the state of a target object vehicle is detected to be driving at high speed according to multiple frame images in a video stream.

In a possible implementation, when the target object is a passerby, the state of the target object may include one or any combination of the following states: the movement state, a body state, and the attribute state. The movement state may include one or any combination of the following states: a position (for example, the relative position of the target object with respect to the current object), a speed (for example, the relative speed of the target object with respect to the current object), an acceleration, a moving direction (for example, the moving direction of the target object with respect to the current object, for example, going straight or turning). The body state may include one or any combination of the following states: looking at the mobile phone, making a phone call, lowering the head, smoking, picking things up and other movements that are completed with the need of limb coordination. The attribute state may include one or any combination of the following states: an age state, the physical state, for example, whether the target object is the aged or children, or whether the target object is a person with limited physical mobility.

The danger level of the passerby may be determined according to the state of the passerby. The danger level of the passerby may include obtaining the danger level of the passerby according to one of the states, and may also include obtaining the danger level of the passerby according to a combination of multiple states. For example, the danger level of the passerby may be determined only according to the position of the passerby: the distance of less than 5 m is set as danger, and the distance of greater than 5 m is set as safety. The danger level of the passerby may also be obtained by combining the speed of the passerby and various states such as whether the passerby is on the phone: the passerby with a speed greater than N m/s and on the phone is determined as a first danger level, the passerby with a speed smaller than N m/s and on the phone is determined as a second danger level, the passerby with a speed greater than N m/s and not on the phone is determined as the third danger level, and the passerby with a speed smaller than N m/s and not on the phone is determined as the fourth danger level. No limitation is made thereto in the present disclosure.

In a possible implementation, when the target object is the vehicle, the state of the target object may include one or any combination of the following states: the movement state, the behavior state, and the attribute state. The movement state may include one or any combination of the following states: the position, the speed, the acceleration, and a direction. The behavior state may include one or any combination of the following states: dangerous driving states. The attribute state may include one or any combination of the following states: a motor vehicle, a non-motor vehicle, and a vehicle type.

The danger level of the vehicle may be determined according to the state of the vehicle. The danger level of the vehicle may include obtaining the danger level of the vehicle according to one of the states, and may also include obtaining the danger level of the vehicle according to a combination of multiple states. For example, the danger level of the vehicle may be determined according to the speed of the vehicle, the vehicle with a speed less than N m/s is determined as safety, and the vehicle with a speed higher than M m/s is determined as danger. The danger level of the vehicle may also be obtained by combining the vehicle type of the vehicle and various states such as whether the vehicle is in a dangerous driving state: for example, in the dangerous driving state including the speed of the vehicle being higher than M m/s, the vehicle type of the vehicle being an older vehicle type, the vehicle swinging from side to side during driving, or the like, the danger level of the vehicle is determined as the first danger level. In the case that the speed of the vehicle is lower than N m/s, and the driving direction of the vehicle and the forward direction of the current object have a crossing point, the danger level of the vehicle is determined as the second danger level. No limitation is made thereto in the present disclosure.

The state of the target object may further include a normal state and an abnormal state. In one example, the abnormal state may be determined according to one or more of the movement state, the body state, and the attribute state. For example, if the passerby is located in front of the current object and the speed is less than a threshold, the abnormal state is determined. For another example, if the passerby is located in front of the current object and the moving direction changes frequently, the abnormal state and the like is determined. Any state other than the abnormal state is determined as the normal state.

In the embodiments, the danger level of the target object is determined according to the state of the target object, and different danger levels may be set by using rich states of the target object according to requirements, so that the collision control is more flexible and precise.

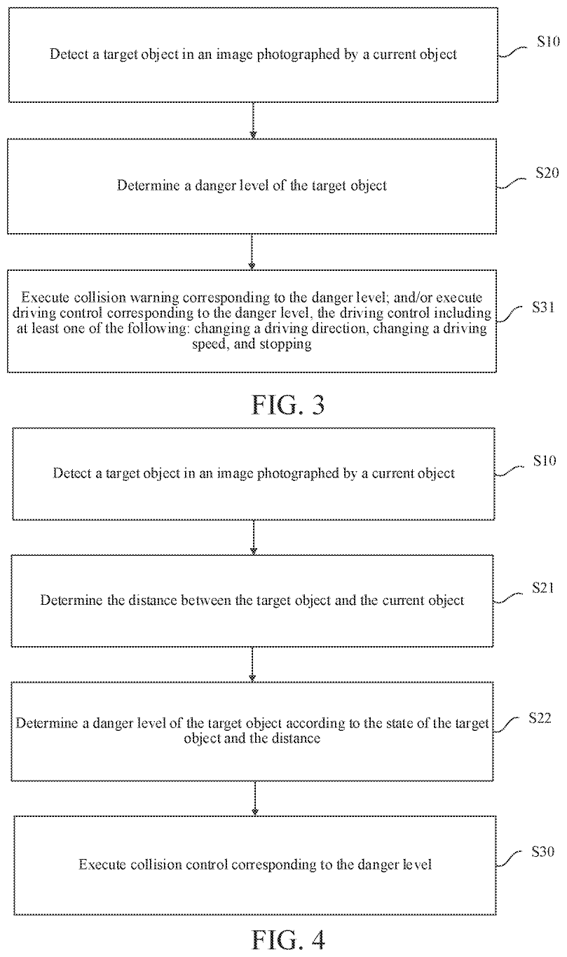

FIG. 3 is a flowchart illustrating a collision control method according to one embodiment of the present disclosure. As shown in FIG. 3, the current object includes a driving object (for example, the vehicle). Step S30 includes the following step.

At step S31: collision warning corresponding to the danger level is performed, and/or driving control corresponding to the danger level is executed, wherein the driving control includes at least one of the following: changing a driving direction, changing a driving speed, and stopping.

Different collision warnings may be set for different danger levels, for example, different voices or display contents, different volumes, different vibration strengths and the like. Triggering a corresponding collision warning according to the determined danger level may help a user of the current object differentiating different danger levels.

For example, if the danger level is the second danger level above, i.e., it is detected that the distance between the target object in the normal state and the current object is greater than a first threshold, the danger degree is lower, and the executed collision warning corresponding to the second danger level may be a voice broadcast: “there is a passerby 3 meters ahead, please stay out of the way”, and may also be an alarm sound of a lower volume. If the danger level is the third danger level above, i.e., it is detected that the distance between the target object in the abnormal state and the current object is smaller than or equal to a second threshold, the danger degree is higher, and the executed collision warning corresponding to the third danger level may be a voice broadcast: “there is a slow-moving passerby within 5 meters ahead, please get out of the way immediately”, and may also be an alarm sound of a higher volume.

Different types of collision warnings may be executed separately or in combination.

The driving control corresponding to the danger level may further be executed, for example, a corresponding driving control mode may be determined according to the danger level, and a driving instruction corresponding to the driving control mode is transmitted to a control system of the vehicle so as to achieve the driving control.

For example, if the danger level is the second danger level above, i.e., it is detected that the distance between the target object in the normal state and the current object is greater than the first threshold, the danger degree is lower, the executed driving control corresponding to the second danger level may be a deceleration, for example, the speed is reduced by 10%. If the danger level is the third danger level above, i.e., it is detected that the distance between the target object in the abnormal state and the current object is smaller than or equal to the second threshold, the danger degree is higher, the executed driving control corresponding to the third danger level may be a greater deceleration, for example, the speed is reduced by 50%, or the vehicle is braked.

One of the collision warning and driving control may be executed, and the both may also be simultaneously executed.

In a possible implementation, executing the driving control may control a vehicle having an automatic driving or assistant driving function. The driving control may include a control action for changing the movement state and/or movement direction of a current driving object, for example, may include: control actions that can change the movement direction and/or the movement state of the current driving object, including changing a driving direction of the current driving object, changing a driving speed thereof, stopping the current driving object and the like. For example, in an actual application scenario, if the original movement direction of the current vehicle having the automatic driving or assistant driving function is to keep going straight in a current lane, if the current vehicle would collide with a suspected collision object ahead on the basis of a collision time, the driving direction of the current vehicle having the automatic driving or assistant driving function may be changed by means of the driving control, so that the current vehicle having the automatic driving or assistant driving function changes a lane to avoid collision. If the suspected collision object ahead accelerates to move away in the process, the driving direction of the current vehicle having the automatic driving or assistant driving function may be changed by means of the driving control, so that the current vehicle having the automatic driving or assistant driving function keeps the original movement direction and keeps going straight in the current lane.

In the embodiments, the corresponding collision warning and/or driving control are determined according to the danger level, so that the collision control may be more targeted, and more precise.

In a possible implementation, the current object includes a static object. The step S30 includes: executing the collision warning corresponding to the danger level.

When the current object is the static object, the collision warning corresponding to the danger level may be performed in a manner similar to that given above to warn that a danger is about to occur.

In a possible implementation, a controller on the current object may be used for implementing the collision control method above.

FIG. 4 is a flowchart illustrating a collision control method according to one embodiment of the present disclosure. As shown in FIG. 4, the step S20 in the collision control method includes the following steps.

At step S21, the distance between the target object and the current object is determined.

At step S22, the danger level of the target object is determined according to the state of the target object and the distance.

In a possible implementation, the distances from two target objects to the current object are equal, but the states of the two target objects are different, resulting in that the two target objects are in different danger levels, for example, passersby are about 10 meters away from the current object, the danger level of the passersby in a running state is higher, and the danger level of the passersby in a static standing state is lower. The danger level of the aged is higher, and the danger level of the young is lower.

The danger level of the target object may be determined after the distance between the target object and the current object and the state of the target object are combined.

In a possible implementation, the state of the target object may include the normal state. The danger level includes the first danger level and the second danger level. The determining the danger level of the target object according to the state of the target object and the distance includes: when the state of the target object is the normal state and the distance is smaller than or equal to a first distance threshold, determining the danger level of the target object to be the first danger level; or when the state of the target object is the normal state and the distance is greater than the first distance threshold, determining the danger level of the target object to be the second danger level.

The danger degree of the first danger level may be higher than that of the second danger level.

In a possible implementation, the state of the target object may include the abnormal state. The danger level includes the third danger level and the fourth danger level. The determining the danger level of the target object according to the state of the target object and the distance includes: when the state of the target object is the abnormal state and the distance is smaller than or equal to a second distance threshold, determining the danger level of the target object to be the third danger level; or when the state of the target object is the abnormal state and the distance is greater than the second distance threshold, determining the danger level of the target object to be the fourth danger level.

The danger degree of the third danger level may be higher than that of the fourth danger level.

The first distance threshold may be smaller than the second distance threshold. For example, for the passerby in the normal state, because the dangerousness is low, a smaller distance threshold (the first distance threshold) may be set, for example, 5 m. For the passerby in the abnormal state (for example, moving slowly, drunk, disabled, aged, etc.), a greater distance threshold (the second distance threshold) may be set, for example, 10 m, so as to perform the collision control as early as possible.

In the embodiments, the danger level is determined by combining the state of the target object and the distance, so that the determination of the danger level is more accurate.

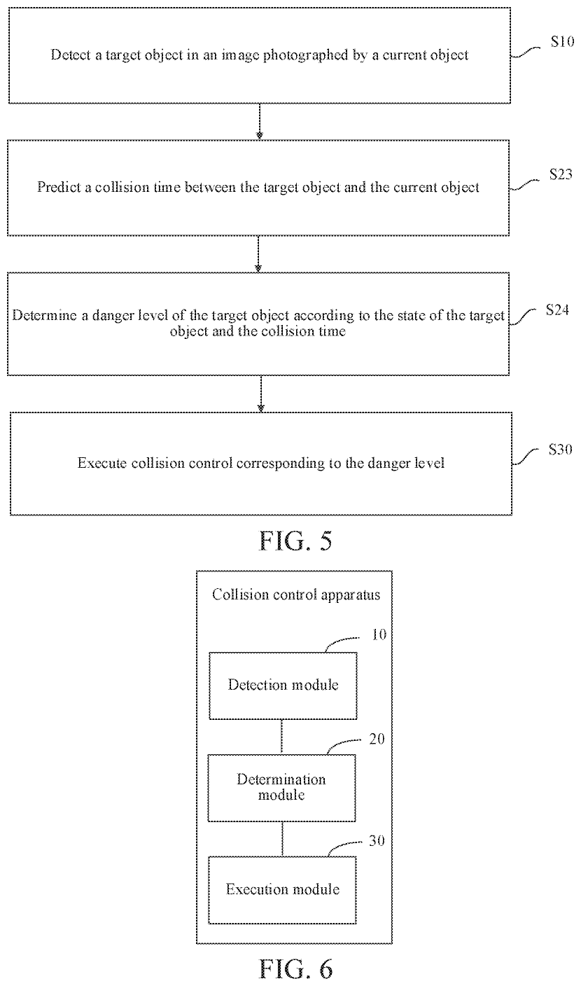

FIG. 5 is a flowchart illustrating a collision control method according to one embodiment of the present disclosure. As shown in FIG. 5, the step S20 in the collision control method includes the following steps.

At step S23, a collision time between the target object and the current object is predicted.

At step S24, the danger level of the target object is determined according to the state of the target object and the collision time.

In a possible implementation, the collision time T between the target object and the current object is determined according to a relative moving direction between the target object and the current object, a distance S in the relative moving direction, and a relative speed V. When the target object and the current object move toward each other, T=S/V.

In a possible implementation, the state of the target object may include the normal state. The danger level may include a fifth danger level and a sixth danger level. The determining the danger level of the target object according to the state of the target object and the collision time may include: when the state of the target object is the normal state and the collision time is smaller than or equal to a first time threshold, determining the danger level of the target object to be the fifth danger level; or when the state of the target object is the normal state and the collision time is greater than the first time threshold, determining the danger level of the target object to be the sixth danger level.

The danger degree of the sixth danger level may be lower than that of the fifth danger level.

In a possible implementation, the state of the target object may include the abnormal state. The danger level may include a seventh danger level and an eighth danger level. The determining the danger level of the target object according to the state of the target object and the collision time may include: when the state of the target object is the abnormal state and the collision time is smaller than or equal to a second time threshold, determining the danger level of the target object to be the seventh danger level; or when the state of the target object is the abnormal state and the collision time is greater than the second time threshold, determining the danger level of the target object to be the eighth danger level.

The danger degree of the eighth danger level may be lower than that of the seventh danger level.

The first time threshold may be smaller than the second time threshold. For example, for the passerby in the normal state, because the dangerousness is low, a smaller time threshold (the first time threshold) may be set, for example, 1 min. For the passerby in the abnormal state (for example, moving slowly, drunk, disabled, aged), a greater time threshold (the second time threshold) may be set, for example, 3 min, so as to perform the collision control as early as possible.

In the embodiments, the danger level is determined by combining the state of the target object and the collision time, so that the determination of the danger level is more accurate.

It can be understood that the foregoing various method embodiments mentioned in the present disclosure may be combined with each other to form a combined embodiment without departing from the principle logic. Details are not described herein again due to space limitation.

In addition, the present disclosure further provides an image processing apparatus, an electronic device, a computer readable storage medium, and a program, which can all be configured to implement any one of the image processing methods provided in the present disclosure. For the corresponding technical solutions and descriptions, please refer to the corresponding contents in the method parts. Details are not described herein again.

FIG. 6 is a block diagram illustrating a collision control apparatus according to one embodiment of the present disclosure. As shown in FIG. 6, the collision control apparatus includes:

a detection module 10, configured to a target object in an image photographed by a current object;

a determination module 20, configured to determine a danger level of the target object; and

an execution module 30, configured to execute collision control corresponding to the danger level.

In the embodiments of the present disclosure, by detecting the target object in the image photographed by the current object and determining the danger level of the target object to perform corresponding collision control, accurate and targeted collision control for the target object is implemented. In a possible implementation, the detection module is configured to detect the target object in the image photographed by the current object by means of a neural network.

In the embodiments, the target object is detected on the basis of the neural network, and the target object may be quickly and accurately detected in the image by using a powerful and accurate detection function of the neural network.

In a possible implementation, the detection module is configured to detect the state of the target object in the image photographed by the current object.

The determination module is configured to determine the danger level of the target object according to the state of the target object.

In the embodiments, the danger level of the target object is determined according to the state of the target object, and different danger levels may be set by using rich states of the target object according to requirements, so that the collision control is more flexible and precise.

In a possible implementation, the current object includes a driving object. The execution module is configured to:

execute collision warning corresponding to the danger level, and/or execute driving control corresponding to the danger level. The driving control includes at least one of the following: changing a driving direction, changing a driving speed, and stopping.

In a possible implementation, the current object includes a static object. The execution module is configured to execute the collision warning corresponding to the danger level.

In the embodiments, the corresponding collision warning and/or driving control are determined according to the danger level, so that the collision control may be more targeted, and more precise.

In a possible implementation, the determination module is configured to:

determine the distance between the target object and the current object; and

determine the danger level of the target object according to the state of the target object and the distance.

In the embodiments, the danger level is determined by combining the state of the target object and the distance, so that the determination of the danger level is more accurate.

In a possible implementation, the state of the target object includes a normal state. The danger level includes a first danger level and a second danger level. The determining the danger level of the target object according to the state of the target object and the distance includes:

when the state of the target object is the normal state and the distance is smaller than or equal to a first distance threshold, determining the danger level of the target object to be the first danger level; or when the state of the target object is the normal state and the distance is greater than the first distance threshold, determining the danger level of the target object to be the second danger level.

In a possible implementation, the state of the target object may include an abnormal state. The danger level includes a third danger level and a fourth danger level. The determining the danger level of the target object according to the state of the target object and the distance includes:

when the state of the target object is the abnormal state and the distance is smaller than or equal to a second distance threshold, determining the danger level of the target object to be the third danger level; or

when the state of the target object is the abnormal state and the distance is greater than the second distance threshold, determining the danger level of the target object to be the fourth danger level.

In a possible implementation, the determination module is configured to:

predict the collision time between the target object and the current object; and

determine the danger level of the target object according to the state of the target object and the collision time.

In a possible implementation, the state of the target object includes the normal state. The danger level includes a fifth danger level and a sixth danger level. The determining the danger level of the target object according to the state of the target object and the collision time includes: when the state of the target object is the normal state and the collision time is smaller than or equal to the first time threshold, determining the danger level of the target object to be the fifth danger level; or

when the state of the target object is the normal state and the collision time is greater than the first time threshold, determining the danger level of the target object to be the sixth danger level.

In a possible implementation, the state of the target object includes the abnormal state. The danger level includes a seventh danger level and an eighth danger level. The determining the danger level of the target object according to the state of the target object and the collision time includes:

when the state of the target object is the abnormal state and the collision time is smaller than or equal to the second time threshold, determining the danger level of the target object to be the seventh danger level; or

when the state of the target object is the abnormal state and the collision time is greater than the second time threshold, determining the danger level of the target object to be the eighth danger level.

In a possible implementation, the target object includes at least one of the following: a passerby, a vehicle, an animal, a plant, an obstacle, a robot, and a building.

In a possible implementation, when the target object is the passerby, the state of the target object includes one or any combination of the following states: a movement state, a body state, and an attribute state.

The movement state includes one or any combination of the following states: a position, a speed, an acceleration, and a moving direction.

The body state includes one or any combination of the following states: picking up articles and lowering the head.

The attribute state includes one or any combination of the following states: an age state and a physical state.

In a possible implementation, when the target object is the vehicle, the state of the target object includes one or any combination of the following states: the movement state, the behavior state, and the attribute state.

The movement state includes one or any combination of the following states: the position, the speed, the acceleration, and the direction.

The behavior state includes one or any combination of the following states: dangerous driving states.

The attribute state includes one or any combination of the following states: a motor vehicle, a non-motor vehicle, and a vehicle type.

In the embodiments of the present disclosure, by detecting the target object in the image photographed by the current object and determining the danger level of the target object to perform corresponding collision control, accurate and targeted collision control for the target object is implemented.

The embodiments of the present disclosure further provide a computer readable storage medium, having computer program instructions stored thereon, wherein when the computer program instructions are executed by the processor, the collision control method is implemented. The computer readable storage medium may be a non-volatile computer readable storage medium.

The embodiments of the present disclosure further provide a computer program, including computer readable codes, wherein when the computer readable codes run in the electronic device, the processor in the electronic device executes instructions for implementing the collision control method.

The embodiments of the present disclosure further provide an electronic device, including: a processor; and a memory configured to store processor-executable instructions, wherein the processor executes the collision control method by directly or indirectly calling the executable instructions.

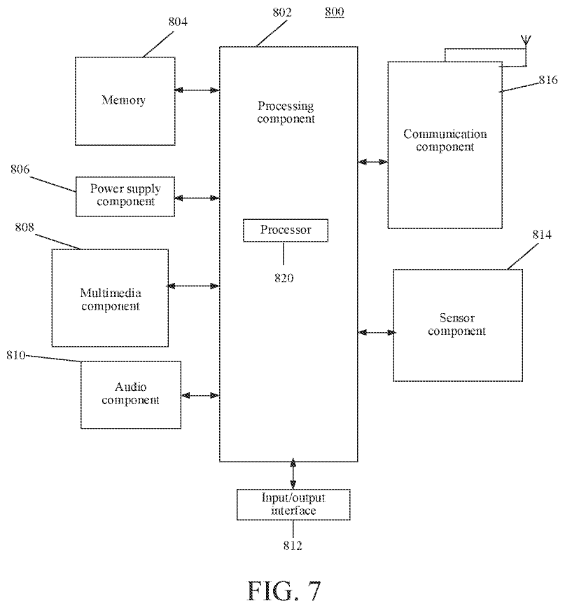

FIG. 7 is a block diagram illustrating an electronic device according to one embodiment of the present disclosure. The electronic device may be provided as a terminal, a server, or devices in other forms. The electronic device may be shown in a block diagram of an apparatus 800 for collision control. For example, the apparatus 800 may be a terminal such as a mobile phone, a computer, a digital broadcast terminal, a message transceiver device, a game console, a tablet device, a medical device, exercise equipment, a personal digital assistant, and a vehicle-mounted device.

With reference to FIG. 7, the apparatus 800 may include one or more of the following components: a processing component 802, a memory 804, a power supply component 806, a multimedia component 808, an audio component 810, an Input/Output (I/O) interface 812, a sensor component 814, and a communication component 816.

The processing component 802 generally controls overall operation of the apparatus 800, such as operations associated with display, phone calls, data communications, camera operations, and recording operations. The processing component 802 may include one or more processors 820 to execute instructions to implement all or some of the steps of the methods above. In addition, the processing component 802 may include one or more modules to facilitate interaction between the processing component 802 and other components. For example, the processing component 802 may include a multimedia module to facilitate interaction between the multimedia component 808 and the processing component 802.

The memory 804 is configured to store various types of data to support operations on the apparatus 800. Examples of the data include instructions for any application or method operated on the apparatus 800, contact data, contact list data, messages, pictures, videos, and the like. The memory 804 may be implemented by any type of volatile or non-volatile storage device, or a combination thereof, such as a Static Random-Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a disk or an optical disk.

The power supply component 806 provides power for various components of the apparatus 800. The power supply component 806 may include a power management system, one or more power supplies, and other components associated with power generation, management, and distribution for the apparatus 800.

The multimedia component 808 includes a screen between the apparatus 800 and a user that provides an output interface. In some embodiments, the screen may include a Liquid Crystal Display (LCD) and a Touch Panel (TP). If the screen includes a TP, the screen may be implemented as a touch screen to receive input signals from the user. The TP includes one or more touch sensors for sensing touches, swipes, and gestures on the TP. The touch sensor may not only sense the boundary of a touch or swipe action, but also detect the duration and pressure related to the touch or swipe operation. In some embodiments, the multimedia component 808 includes a front-facing camera and/or a rear-facing camera. When the apparatus 800 is in an operation mode, for example, a photography mode or a video mode, the front-facing camera and/or the rear-facing camera may receive external multimedia data. Each of the front-facing camera and the rear-facing camera may be a fixed optical lens system, or have focal length and optical zoom capabilities.

The audio component 810 is configured to output and/or input an audio signal. For example, the audio component 810 includes a microphone (MIC), and the microphone is configured to receive an external audio signal when the apparatus 800 is in an operation mode, such as a calling mode, a recording mode, and a voice recognition mode. The received audio signal may be further stored in the memory 804 or transmitted by means of the communication component 816. In some embodiments, the audio component 810 further includes a speaker for outputting the audio signal.

The I/O interface 812 provides an interface between the processing component 802 and a peripheral interface module, which may be a keyboard, a click wheel, a button, etc. The button may include, but is not limited to, a home button, a volume button, a start button, and a lock button.

The sensor assembly 814 includes one or more sensors for providing state assessment in various aspects for the apparatus 800. For example, the sensor component 814 may detect an on/off state of the apparatus 800, and relative positioning of components, which are the display and keypad of the apparatus 800, for example, and the sensor assembly 814 may further detect a position change of the apparatus 800 or a component of the apparatus 800, the presence or absence of contact of the user with the apparatus 800, the orientation or acceleration/deceleration of the apparatus 800, and a temperature change of the apparatus 800. The sensor component 814 may include a proximity sensor, which is configured to detect the presence of a nearby object when there is no physical contact. The sensor component 814 may further include a light sensor, such as a CMOS or CCD image sensor, for use in an imaging application. In some embodiments, the sensor component 814 may further include an acceleration sensor, a gyroscope sensor, a magnetic sensor, a pressure sensor, or a temperature sensor.

The communication component 816 is configured to facilitate wired or wireless communications between the apparatus 800 and other devices. The apparatus 800 may access a wireless network based on a communication standard, such as WiFi, 2G, or 3G, or a combination thereof. In an exemplary embodiment, the communication component 816 receives a broadcast signal or broadcast-related information from an external broadcast management system by means of a broadcast channel. In an exemplary embodiment, the communication component 816 further includes a Near Field Communication (NFC) module to facilitate short-range communication. For example, the NFC module may be implemented based on Radio Frequency Identification (RFID) technology, Infrared Data Association (IrDA) technology, Ultra-Wideband (UWB) technology, Bluetooth (BT) technology, and other technologies.

In an exemplary embodiment, the apparatus 800 may be implemented by one or more Application-Specific Integrated Circuits (ASICs), Digital Signal Processors (DSPs), Digital Signal Processing Devices (DSPDs), Programmable Logic Devices (PLDs), Field-Programmable Gate Arrays (FPGAs), controllers, microcontrollers, microprocessors, or other electronic elements, to execute the method above.

In an exemplary embodiment, a non-volatile computer-readable storage medium is further provided, for example, a memory 804 including computer program instructions, which may be executed by the processor 820 of the apparatus 800 to implement the method above.

The present disclosure may be a system, a method, and/or a computer program product. The computer program product may include a computer readable storage medium having computer readable program instructions thereon for enabling a processor to implement aspects of the present disclosure.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. More specific examples (a non-exhaustive list) of the computer readable storage medium include: a portable computer diskette, a hard disk, a Random Access Memory (RAM), an ROM, an EPROM (or a flash memory), a SRAM, a portable Compact Disk Read-Only Memory (CD-ROM), a Digital Versatile Disc (DVD), a memory stick, a floppy disk, a mechanically encoded device such as punch-cards or raised structure in a groove having instructions stored thereon, and any suitable combination thereof. A computer readable storage medium, as used herein, is not to be construed as being transitory signals per se, such as radio waves or other freely propagating electromagnetic waves, electromagnetic waves propagating by means of a waveguide or other transmission media (e.g., light pulses passing through a fiber-optic cable), or electrical signals transmitted by means of a wire.

Computer-readable program instructions described herein may be downloaded to respective computing/processing devices from the computer readable storage medium or to an external computer or external storage device by means of a network, for example, the Internet, a Local Area Network (LAN), a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer program instructions for performing operations of the present disclosure may be assembler instructions, Instruction-Set-Architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” language or similar programming languages. Computer readable program instructions may be executed completely on a user computer, executed partially on the user computer, executed as an independent software package, executed partially on the user computer and partially on a remote computer, or executed completely on the remote computer or server. In a scenario involving the remote computer, the remote computer may be connected to the user computer by means of any type of network, including a LAN or a Wide Area Network (WAN), or the connection may be made to an external computer (for example, connecting by using an Internet service provider by means of the Internet). In some embodiments, electronic circuitry including, for example, programmable logic circuitry, the FGPAs, or Programmable Logic Arrays (PLAs) may execute the computer readable program instructions by utilizing state information of the computer readable program instructions to personalize the electronic circuitry, so as to implement the aspects of the present disclosure.

The aspects of the present disclosure are described herein with reference to flowcharts and/or block diagrams of methods, apparatuses (systems), and computer program products according to the embodiments of the present disclosure. It should be understood that each block of the flowcharts and/or block diagrams, and combinations of the blocks in the flowcharts and/or block diagrams may be implemented by the computer readable program instructions.

These computer readable program instructions may be provided to a processor of a general-purpose computer, special-purpose computer, or other programmable data processing apparatus to produce a machine, such that the instructions, which execute by means of the processor of the computer or other programmable data processing apparatuses, create means for executing the functions/actions specified in one or more blocks of the flowcharts and/or block diagrams. These computer readable program instructions may also be stored in the computer readable storage medium, the instructions enable the computer, the programmable data processing apparatus, and/or other devices to function in a particular manner, so that the computer readable medium having instructions stored therein includes an article of manufacture including instructions which implement the aspects of the functions/actions specified in one or more blocks of the flowcharts and/or block diagrams.

The computer readable program instructions may also be loaded onto a computer, other programmable data processing apparatuses, or other devices to cause a series of operational steps to be performed on the computer, other programmable apparatuses or other devices to produce a computer implemented process, so that the instructions which execute on the computer, other programmable apparatuses or other devices implement the functions/actions specified in one or more blocks of the flowcharts and/or block diagrams.

The flowcharts and block diagrams in the accompanying drawings illustrate the architecture, functionality and operations of possible implementations of systems, methods, and computer program products according to multiple embodiments of the present disclosure. In this regard, each block in the flowchart or block diagram may represent a module, program segment, or portion of instruction, which includes one or more executable instructions for executing the specified logical function. In some alternative implementations, the functions noted in the block may also occur out of the order noted in the accompanying drawings. For example, two blocks shown in succession may, in fact, be executed substantially concurrently, or the blocks may sometimes be executed in the reverse order, depending upon the functionality involved. It should also be noted that each block of the block diagrams and/or flowcharts, and combinations of blocks in the block diagrams and/or flowcharts, may be implemented by special purpose hardware-based systems that perform the specified functions or actions or implemented by combinations of special purpose hardware and computer instructions.

The descriptions of the embodiments of the present disclosure have been presented for purposes of illustration, but are not intended to be exhaustive or limited to the embodiments disclosed. Many modifications and variations will be apparent to persons of ordinary skill in the art without departing from the scope and spirit of the described embodiments. The terminology used herein was chosen to best explain the principles of the embodiments, the practical application or technical improvement over technologies found in the marketplace, or to enable other persons of ordinary skill in the art to understand the embodiments disclosed herein.

What is claimed is:

1. A collision control method, comprising:
detecting a target object in an image photographed by a current object;
determining a danger level of the target object; and
executing collision control corresponding to the danger level.

2. The method according to claim 1, wherein detecting the target object in the image photographed by the current object comprises: detecting the target object in the image photographed by the current object by means of a neural network.

3. The method according to claim 1 or 2, wherein detecting the target object in the image photographed by the current object comprises:
detecting the state of the target object in the image photographed by the current object; and
determining the danger level of the target object comprises:
determining the danger level of the target object according to the state of the target object.

4. The method according to claim 1, wherein the current object comprises a driving object, and executing the collision control corresponding to the danger level comprises:
executing collision warning corresponding to the danger level, and/or
executing driving control corresponding to the danger level, the driving control comprising at least one of the following: changing a driving direction, changing a driving speed, and stopping.

5. The method according to claim 1, wherein the current object comprises a static object, and executing the collision control corresponding to the danger level comprises:
executing the collision warning corresponding to the danger level.

6. The method according to claim 3, wherein determining the danger level of the target object comprises:
determining the distance between the target object and the current object; and
determining the danger level of the target object according to the state of the target object and the distance.

7. The method according to claim 6, wherein the state of the target object comprises a normal state, the danger level comprises a first danger level and a second danger level, and determining the danger level of the target object according to the state of the target object and the distance comprises:
when the state of the target object is the normal state and the distance is smaller than or equal to a first distance threshold, determining the danger level of the target object to be the first danger level; or
when the state of the target object is the normal state and the distance is greater than the first distance threshold, determining the danger level of the target object to be the second danger level.

8. The method according to claim 6, wherein the state of the target object comprises an abnormal state, the danger level comprises a third danger level and a fourth danger level, and determining the danger level of the target object according to the state of the target object and the distance comprises:
when the state of the target object is the abnormal state and the distance is smaller than or equal to a second distance threshold, determining the danger level of the target object to be the third danger level, or
when the state of the target object is the abnormal state and the distance is greater than the second distance threshold, determining the danger level of the target object to be the fourth danger level.

9. The method according to claim 3, wherein determining the danger level of the target object comprises:
predicting a collision time between the target object and the current object; and
determining the danger level of the target object according to the state of the target object and the collision time.

10. The method according to claim 9, wherein the state of the target object comprises the normal state, the danger level comprises a fifth danger level and a sixth danger level, and determining the danger level of the target object according to the state of the target object and the collision time comprises:
when the state of the target object is the normal state and the collision time is smaller than or equal to the first time threshold, determining the danger level of the target object to be the fifth danger level; or
when the state of the target object is the normal state and the collision time is greater than the first time threshold, determining the danger level of the target object to be the sixth danger level.

11. The method according to claim 9, wherein the state of the target object comprises the abnormal state, the danger level comprises a seventh danger level and an eighth danger level, and determining the danger level of the target object according to the state of the target object and the collision time comprises:
when the state of the target object is the abnormal state and the collision time is smaller than or equal to the second time threshold, determining the danger level of the target object to be the seventh danger level; or
when the state of the target object is the abnormal state and the collision time is greater than the second time threshold, determining the danger level of the target object to be the eighth danger level.

12. The method according to claim 1, wherein the target object comprises at least one of the following: a passerby, a vehicle, an animal, a plant, an obstacle, a robot, or a building.

13. The method according to claim 1, wherein when the target object is a passerby, the state of the target object comprises one or any combination of the following states: a movement state, a body state, and an attribute state;
the movement state comprises one or any combination of the following states: a position, a speed, an acceleration, and a moving direction;
the body state comprises one or any combination of the following states: picking up articles, lowering the head, looking at a mobile phone, making a phone call, and smoking;
the attribute state comprises one or any combination of the following states: an age state and a physical state,
the state of the target object comprises an abnormal state, and the abnormal state is determined according to one or more of the movement states, the body state, and the attribute state.

14. The method according to claim 1, wherein when the target object is a vehicle, the state of the target object comprises one or any combination of the following states: a movement state, a behavior state, and an attribute state; wherein
the movement state comprises one or any combination of the following states: the position, the speed, the acceleration, and a direction;
the behavior state comprises one or any combination of the following states: dangerous driving states;
the attribute state comprises one or any combination of the following states: a motor vehicle, a non-motor vehicle, and a vehicle type; and
the dangerous driving states comprise the vehicle swinging from side to side during driving.

15-28. (canceled)

29. An electronic device, comprising:
a processor; and
a memory configured to store processor-executable instructions which, when executed by the processor, cause the processor to execute a collision control method, comprising:
detecting a target object in an image photographed by a current object;
determining a danger level of the target object; and
executing collision control corresponding to the danger level.

30. A non-transitory computer readable storage medium, having computer program instructions thereon, wherein when the computer program instructions are executed by a processor, the processor is caused to implement a collision control method, comprising:
detecting a target object in an image photographed by a current object;
determining a danger level of the target object; and
executing collision control corresponding to the danger level.

31. (canceled)

32. The electronic device according to claim 29, wherein detecting the target object in the image photographed by the current object comprises detecting the target object in the image photographed by the current object by means of a neural network, and/or
detecting the target object in the image photographed by the current object comprises detecting the state of the target object in the image photographed by the current object, and determining the danger level of the target object comprises determining the danger level of the target object according to the state of the target object.

33. The electronic device according to claim 29, wherein
the current object comprises a driving object, and executing the collision control corresponding to the danger level comprises executing collision warning corresponding to the danger level, and/or executing driving control corresponding to the danger level, the driving control comprising at least one of the following: changing a driving direction, changing a driving speed, and stopping, and/or
the current object comprises a static object, and executing the collision control corresponding to the danger level comprises executing the collision warning corresponding to the danger level.

34. The electronic device according to claim 32, wherein determining the danger level of the target object comprises:
determining the distance between the target object and the current object, and determining the danger level of the target object according to the state of the target object and the distance; and/or
predicting a collision time between the target object and the current object, and determining the danger level of the target object according to the state of the target object and the collision time.

35. The electronic device according to claim 34, wherein
the state of the target object comprises a normal state, the danger level comprises a first danger level and a second danger level, and determining the danger level of the target object according to the state of the target object and the distance comprises: when the state of the target object is the normal state and the distance is smaller than or equal to a first distance threshold, determining the danger level of the target object to be the first danger level; or when the state of the target object is the normal state and the distance is greater than the first distance threshold, determining the danger level of the target object to be the second danger level, and/or
the state of the target object comprises an abnormal state, the danger level comprises a third danger level and a fourth danger level, and determining the danger level of the target object according to the state of the target object and the distance comprises: when the state of the target object is the abnormal state and the distance is smaller than or equal to a second distance threshold, determining the danger level of the target object to be the third danger level, or when the state of the target object is the abnormal state and the distance is greater than the second distance threshold, determining the danger level of the target object to be the fourth danger level, and/or
the state of the target object comprises the normal state, the danger level comprises a fifth danger level and a sixth danger level, and determining the danger level of the target object according to the state of the target object and the collision time comprises: when the state of the target object is the normal state and the collision time is smaller than or equal to the first time threshold, determining the danger level of the target object to be the fifth danger level; or when the state of the target object is the normal state and the collision time is greater than the first time threshold, determining the danger level of the target object to be the sixth danger level, and/or
the state of the target object comprises the abnormal state, the danger level comprises a seventh danger level and an eighth danger level, and determining the danger level of the target object according to the state of the target object and the collision time comprises: when the state of the target object is the abnormal state and the collision time is smaller than or equal to the second time threshold, determining the danger level of the target object to be the seventh danger level; or when the state of the target object is the abnormal state and the collision time is greater than the second time threshold, determining the danger level of the target object to be the eighth danger level.
